(19) United States
(12) Patent Application Publication
(10) Pub. No.: US 2021/0069054 A1
(43) Pub. Date: Mar. 11, 2021

(54) Massage Scraping Apparatus

(71) Applicants: Yuechuan Bi, Columbus (US); Li Zhang, Columbus (US)

(72) Inventors: Yuechuan Bi, Columbus (US); Li Zhang, Columbus (US)

(21) Appl. No.: 16/952,110

(22) Filed: Nov. 19, 2020

(30) Foreign Application Priority Data
Oct. 29, 2020 (CN) 202022434098.5

(51) Int. Cl. A61H 7/00; A47H 1/02; E04H 1/12

(52) U.S. Cl. CPC A61H 7/002; A47H 1/02; E04H 1/12; A47H 2001/0205; A61H 2201/0192; A61H 2203/0406; A61H 2201/0119

(57) ABSTRACT

The present invention discloses a massage scraping apparatus, which is characterized by comprising a base, a support frame, and massaging and scraping sticks; a pedal is arranged on the base; the tail ends of the support frame are fixedly connected with the base; and the massaging and scraping sticks are vertically connected with the support frame. The human body can obtain the effects of skin scraping and massage through repeated friction on the apparatus of the present invention. The apparatus of the present invention stimulates the acupoints on the neck and back to promote blood circulation to remove blood stasis, which greatly improves the microcirculation of the above parts and relaxes the muscles of the neck and back so as to achieve physical and mental pleasure.

### TECHNICAL FIELD

The present invention relates to the technical field of body-building apparatuses, and in particular to a massage scraping apparatus.

### BACKGROUND

Skin scraping means using the theory of meridians and acupuncture points in traditional Chinese medicine as the guide, adopting special scraping apparatuses and corresponding techniques, dipping the apparatuses in a certain medium, and repeatedly scraping and rubbing the body surface to cause part of the skin to have “acture diseases” changes such as red miliary points or dark red blood points so as to achieve the effect of promoting blood circulation and eliminating toxin. With the characteristics of simplicity, convenience, low cost and efficiency, skin scraping is widely used in clinical practice and is suitable for medical care and home health care.

The existing scraping apparatuses cannot be used in combination with massage, acupuncture and other methods in traditional Chinese medicine. Therefore, the problem to be urgently solved by those skilled in the art is to provide an active massage scraping apparatus for neck, shoulders, lower back and limbs combining skin scraping, massage and acupuncture in traditional Chinese medicine.

### SUMMARY

In view of this, the present invention provides an active massage scraping apparatus for neck, shoulders, lower back and limbs combining skin scraping, massage and acupuncture in traditional Chinese medicine.

To achieve the above purpose, the present invention adopts the following technical solution:

A massage scraping apparatus is characterized by comprising a base, a support frame, and massaging and scraping sticks;

A petal is arranged on the base and forms an included angle of 5° with the base;

The tail ends of the support frame are fixedly connected with the base;

The massaging and scraping sticks are vertically connected with the support frame.

Further, the massage scraping apparatus also comprises sliding valves, and the massaging and scraping sticks are vertically connected with the support frame through the sliding valves.

Further more, a plurality of massaging and scraping sticks are provided and vertically connected with the support frame in a manner of parallel arrangement.

The beneficial effect of adopting the above further technical solution is: the user actively massages, scrapes and rubs the surfaces of the massaging and scraping sticks, which is regarded as that the massaging and scraping sticks have the technical effect of scraping and massaging the skin based on the relative movement. The plurality of massaging and scraping sticks can increase the area of effect on the lower back.

Further, the support frame comprises support rods and a connecting piece; The support rods comprise a first support rod and a second support rod, and the tail ends of the first support rod and the second support rod are fixed in parallel to the base and form an included angle of 85° with the base;

The head ends of the first support rod and the second support rod are fixedly connected through the connecting rod.

Further more, both ends of the massaging and scraping sticks are vertically connected with the first support rod and the second support rod through the sliding valves respectively.

The beneficial effect of adopting the above further technical solution is: the above structure is used for lifting the massaging and scraping sticks to the lower back of the user.

Further, the massage scraping apparatus also comprises springs and y-shaped brackets;

One end of each spring is fixed to the top end of the base, the other end is connected with the tail end of the y-shaped bracket, and the head ends of the y-shaped bracket are fixed on the support rod.

The beneficial effect of adopting the above further technical solution is: the springs defined in the present invention have the function of flexible connection, and the massaging and scraping sticks can always be close to the back of the user under the tension of the springs.

Further, the massage scraping apparatus also comprises a U-shaped rod, wherein the U-shaped rod is detachably connected with both sides of the connecting rod or the support rods.

Further more, the massage scraping apparatus also comprises a cloth shelter, wherein a plurality of rings are arranged on one side of the cloth shelter and sheathed on the U-shaped rod.

The beneficial effect of adopting the above further technical solution is: the present invention adopts the cloth shelter to prevent the user from disturbing others.

Further, the massage scraping apparatus also comprises a sole massaging and scraping stick, wherein the sole massaging and scraping stick is fixed to the joints of the base and the support rods.

The beneficial effect of adopting the above further technical solution is: the Yongquan acupoint of the sole can be massaged so as to promote kidney health and play the roles of keeping health such as invigorating the kidney, nourishing the kidney and improving eyesight.

Further, bearings are arranged at the joints of the support frame and the base. The present invention has the following beneficial effects: the human body can obtain the effects of skin scraping and massage through repeated friction on the apparatus of the present invention. The apparatus of the present invention stimulates the acupoints on the neck and back to promote blood circulation to remove blood stasis, which greatly improves the microcirculation of the above parts and relaxes the muscles of the neck and back so as to achieve physical and mental pleasure. The main function of the apparatus of the present invention is skin scraping. After use, the skin will be slightly red. The massage scraping apparatus of the present invention does not affect bathing, and can be used two or three times on the same day.

### DESCRIPTION OF DRAWINGS

FIG. 1 is a sectional structural schematic diagram of a massage scraping apparatus of the present invention;

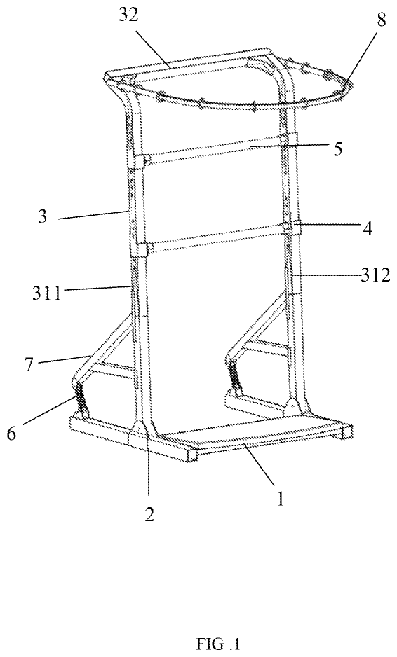

FIG. 2 is a structural schematic diagram of a massage scraping apparatus of the present invention in use;

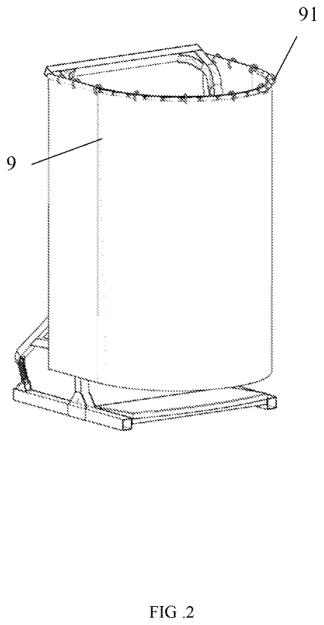

FIG. 3 is a side structural schematic diagram of a massage scraping apparatus of the present invention;

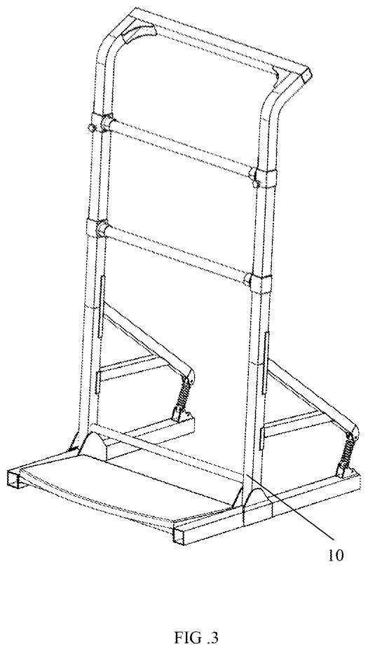

In the figures, the structures represented by numerals are listed as follows: 1—pedal, 2—base, 3—support frame, 4—sliding valve, 5—massaging and scraping stick, 6—spring, 7—y-shaped bracket, 8—U-shaped rod, 9—cloth shelter, and 10—sole massaging and scraping stick;
311—first support rod, 312—second support rod, 32—connecting rod, and 91—ring.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

It should be understood in the description of the embodiments of the present invention that terms such as “upper”, “lower”, “front”, “rear”, “left”, “right”, “vertical”, “horizontal”, “top”, “bottom”, “inner” and “outer” indicate direction or position relationships shown based on the drawings, and are only intended to facilitate the description of the present invention and the simplification of the description rather than to indicate or imply that the indicated device or element must have a specific direction or constructed and operated in a specific direction, and therefore, shall not be understood as a limitation to the present invention.

In addition, the terms such as “first” and “second” are only used for the purpose of description, rather than being understood to indicate or imply relative importance or hint the number of indicated technical features. Thus, the feature limited by “first” and “second” can explicitly or impliedly comprise one or more features. In the description of the present invention, the meaning of “a plurality of” is two or more unless otherwise clearly specified.

In the embodiments of the present invention, unless otherwise specifically regulated and defined, terms such as “installation”, “connected”, “connecting”, “fixation” and the like shall be understood in broad sense, and for example, may refer to fixed connection or detachable connection or integral connection, may refer to mechanical connection or electrical connection, and may refer to direct connection or indirect connection through an intermediate medium or inner communication of two elements or interaction relationship of two elements. For those ordinary skilled in the art, the specific meanings of the above terms in the present invention may be understood according to concrete conditions.

In the embodiments of the present invention, unless otherwise clearly specified and defined, a first feature is “above” or “below” a second feature comprises that the first feature and the second feature come into direct contact or the first feature and the second feature come into contact through additional features thereof instead of direct contact. Moreover, the first feature is “on”, “above” and “over” the second feature comprises that the first feature is directly above or slightly above the second feature, or just indicates that the horizontal height of the first feature is higher than that of the second feature. The first feature is “under”, “below” and “beneath” the second feature comprises that the first feature is directly below or slightly below the second feature, or just indicates that the horizontal height of the first feature is lower than that of the second feature.

### EMBODIMENTS

A massage scraping apparatus is characterized by comprising a base 2, a support frame 3, and massaging and scraping sticks 5;

A petal 1 is arranged on the base 2 and forms an included angle of 5° with the base 2;

The tail ends of the support frame 3 are fixedly connected with the base 2;

The massaging and scraping sticks 5 are vertically connected with the support frame 3.

In one embodiment, the massage scraping apparatus also comprises sliding valves 4, and the massaging and scraping sticks 5 are vertically connected with the support frame 3 through the sliding valves 4.

In another embodiment, a plurality of massaging and scraping sticks 5 are provided and vertically connected with the support frame 3 in a manner of parallel arrangement.

In one embodiment, the support frame 3 comprises support rods 31 and a connecting piece 32;

The support rods 31 comprise a first support rod 311 and a second support rod 312, and the tail ends of the first support rod 311 and the second support rod 312 are fixed in parallel to the base 2 and form an included angle of 85° with the base 2;

The head ends of the first support rod 311 and the second support rod 312 are fixedly connected through the connecting rod 32.

In another embodiment, both ends of the massaging and scraping sticks 5 are vertically connected with the first support rod 311 and the second support rod 312 through the sliding valves 4 respectively.

In one embodiment, the massage scraping apparatus also comprises springs 6 and y-shaped brackets 7;

One end of each spring 6 is fixed to the top end of the base 2, the other end is connected with the tail end of the y-shaped bracket 7, and the head ends of the y-shaped bracket 7 are fixed on the support rod 31.

In one embodiment, the massage scraping apparatus also comprises a U-shaped rod 8, wherein the U-shaped rod 8 is detachably connected with both sides of the connecting rod 32 or the support rods 31.

In another embodiment, the massage scraping apparatus also comprises a cloth shelter 9, wherein a plurality of rings 91 are arranged on one side of the cloth shelter and sheathed on the U-shaped rod 8.

In one embodiment, the massage scraping apparatus also comprises a sole massaging and scraping stick 10, wherein the sole massaging and scraping stick 10 is fixed to the joints of the base 2 and the support rods 31.

In one embodiment, bearings are arranged at the joints of the support frame 3 and the base 2.

The present invention abandons many disadvantages of the traditional skin scraping, the matching of the bearings and springs of the base causes the massage scraping apparatus of the present invention to swing slightly in use, and at this time, the massaging and scraping sticks move for a small distance relative to the human body in the same direction so as to keep the scraping apparatus in deeper contact with the body for a longer time, which greatly improves the skin scraping effect without blood points or blood stasis. The apparatus of the present invention can be used for massaging and scraping the skin for many times on the same day, which is more beneficial to the health.

The method for using the massage scraping apparatus of the embodiment is as follows: stepping on the pedal with both feet, and making the parts to be massaged and scraped lean against the massaging and scraping sticks; slighting bending both legs, moving the body up and down, actively massaging and scraping uncomfortable body parts, or rotating left and right with the waist as the axis to achieve the purpose of massaging and scraping; and rotating left and right with the waist as the axis, and meanwhile, swinging up and down

The working range of the massage scraping apparatus of the embodiment on the back is divided into the upper back and the lower back. On the upper back, the acupoints acting on the cervical vertebra include: Dazhui, Bingfeng and Naoshu; the acupoints acting on the lung include: Feishu, Taodao, Lingtai and Dingchuan; and the acupoints acting on the shoulder include: Jianzhen, Tianzong and Naoshu.

On the lower back, the acupoints acting on the heart include: Xinshu, Shendao, Zhiyang and Jiaji; and the acupoints acting on the kidney include: Mingmen, Yaoyangguan and Changqiang.

Each time of using the massage scraping apparatus of the embodiment is determined according to the physique, weight and physical condition of the user; for fat people, the time shall be controlled to about 5 min; and for physically poor people with obvious symptoms on shoulders, neck and other parts, the massaging and scraping time can be increased to about 15 min.

For skinny people, each time of massaging and scraping shall be controlled to 8-10 min; for people slightly feeling indisposed, the time shall be controlled to 15-20 min; and the massaging and scraping strength shall be relatively low for skinny people, shall be relatively high for people with thick subcutaneous fat and muscles, and shall be reduced appropriately if the user feels tingly in the process of massaging and scraping.

Massaging and scraping of four limbs is mainly for the pain part of muscle sprain of four limbs. Zusanli on the outer side of the leg under the knee is one of the three most important health care acupoints. Massaging and scraping of Zusanli can achieve many health effects. The most important one is that this is beneficial to gastrointestinal health, and frequent massaging and scraping has a very significant effect on indigestion.

The method for massaging and scraping Zusanli is as follows: facing the massaging and scraping sticks sideways, holding the massaging and scraping sticks with both hands, adjusting the lower stick to a suitable position, standing on one foot, and carefully massaging and scraping. The strength shall be moderate and is appropriate when the user feels acceptable, and too much force is not required.

For massaging and scraping of the back, neck, shoulders and waist, the user shall wear tight-fitting clothes, preferably made of purified cotton, during the whole process of massaging and scraping. The massaging and scraping of four limbs and Zusanli can depend on the condition.

Although the embodiments of the present invention have been shown and described above, it will be appreciated that the above embodiments are exemplary and shall not be understood as limitations to the present invention. Those ordinary skilled in the art can make changes, amendments, replacements and variations to the above embodiments within the scope of the present invention.

1. A massage scraping apparatus, characterized by comprising a base, a support frame, and massaging and scraping sticks;
wherein a petal is arranged on the base and forms an included angle of 5° with the base;
the tail ends of the support frame are fixedly connected with the base;
the massaging and scraping sticks are vertically connected with the support frame.

2. The massage scraping apparatus according to claim 1, characterized by also comprising sliding valves, wherein the massaging and scraping sticks are vertically connected with the support frame through the sliding valves.

3. The massage scraping apparatus according to claim 2, characterized in that a plurality of massaging and scraping sticks are provided and vertically connected with the support frame in a manner of parallel arrangement.

4. The massage scraping apparatus according to claim 3, characterized in that the support frame comprises support rods and a connecting piece;
the support rods comprise a first support rod and a second support rod, and the tail ends of the first support rod and the second support rod are fixed in parallel to the base and form an included angle of 85° with the base;
the head ends of the first support rod and the second support rod are fixedly connected through the connecting rod.

5. The massage scraping apparatus according to claim 4, characterized in that both ends of the massaging and scraping sticks are vertically connected with the first support rod and the second support rod through the sliding valves respectively.

6. The massage scraping apparatus according to claim 4, characterized by also comprising springs and y-shaped brackets;
one end of each spring is fixed to the top end of the base, the other end is connected with the tail end of the y-shaped bracket, and the head ends of the y-shaped bracket are fixed on the support rod.

7. The massage scraping apparatus according to claim 4, characterized by also comprising a U-shaped rod, wherein the U-shaped rod is detachably connected with both sides of the connecting rod or the support rods.

8. The massage scraping apparatus according to claim 7, characterized by also comprising a cloth shelter, wherein a plurality of rings are arranged on one side of the cloth shelter and sheathed on the U-shaped rod.

9. The massage scraping apparatus according to claim 1, characterized by also comprising a sole massaging and scraping stick, wherein the sole massaging and scraping stick is fixed to the joints of the base and the support rods.

10. The massage scraping apparatus according to claim 1, characterized in that bearings are arranged at the joints of the support frame and the base.
